(19) United States
(12) Patent Application Publication
(10) Pub. No.: US 2026/0352390 A1
(43) Pub. Date: Nov. 5, 2026

(54) SYSTEMS AND METHODS FOR BETA OFFSET CONFIGURATION FOR TRANSMITTING UPLINK CONTROL INFORMATION

(71) Applicant: Telefonaktiebolaget LM Ericsson (PUBL), Stockholm (SE)

(72) Inventors: Jingya LI, GÖTEBORG (SE); Daniel CHEN LARSSON, LUND (SE); Roy TIMO, KUNGSÄNGEN (SE); Yufei BLANKENSHIP, KILDEER, IL (US); Henrik RYDÉN, STOCKHOLM (SE); Xinlin ZHANG, VÄSTRA FRÖLUNDA (SE)

(21) Appl. No.: 19/115,843

(22) PCT Filed: Sep. 29, 2023
(86) PCT No.: PCT/SE2023/050962

§ 371 Date: Mar. 27, 2025

Related U.S. Application Data
(60) Provisional application No. 63/411,977, filed on Sep. 30, 2022.

(51) Int. Cl. H04L 5/00; H04L 41/16

(52) U.S. Cl. CPC H04L 5/0044; H04L 41/16

(57) ABSTRACT

A method (700) by a user equipment, UE (112), for determining beta offset values for transmitting uplink control information, UCI, includes receiving (702), from a network node (110), at least one beta offset value. The UE transmits (704) the UCI to the network node. The UCI includes one or more bits that are allocated into one or more bit buckets based on the at least one beta offset value. The one or more bit buckets are generated based on an Artificial Intelligence, AI, model.

### TECHNICAL FIELD

The present disclosure relates, in general, to wireless communications and, more particularly, systems and methods for beta offset configuration for transmitting Uplink Control Information (UCI).

### BACKGROUND

Artificial Intelligence (AI) and Machine Learning (ML) have been investigated, both in academia and industry, as promising tools to optimize the design of the air-interface in wireless communication networks. Example use cases include using autoencoders for Channel State Information (CSI) compression to reduce the feedback overhead and improve channel prediction accuracy; using deep neural networks for classifying Line-of-Sight (LOS) and Non-LOS (NLOS) conditions to enhance the positioning accuracy; and using reinforcement learning for beam selection at the network side and/or the User Equipment (UE) side to reduce the signaling overhead and beam alignment latency; using deep reinforcement learning to learn an optimal precoding policy for complex Multiple Input Multiple Output (MIMO) precoding problems.

In 3rd Generation Partnership Project (3GPP) New Radio (NR) standardization work, a new Release 18 study item on AI/ML for the NR air interface began in May 2022. This study item is to explore the benefits of augmenting the air-interface with features enabling improved support of AI/ML-based algorithms for enhanced performance and/or reduced complexity/overhead. Through studying a few selected use cases (e.g., CSI feedback, beam management, and positioning), the study item aims at laying the foundation for future air-interface use cases leveraging AI/ML techniques.

Building the AI model, or any machine learning model, includes several development steps where the actual training of the AI model is just one step in a training pipeline. An important part in AI development is the ML model lifecycle management. This is illustrated in FIG. 1, which is an illustration of training and inference pipelines, and their interactions within a model lifecycle management procedure.

The model lifecycle management typically consists of:
A training (re-training) pipeline that may include:
   Data Ingestion: Data ingestion refers to gathering raw (training) data from a data storage. After data ingestion, there may also be a step that controls the validity of the gathered data.
   Data Pre-Processing: Data pre-processing refers to some feature engineering applied to the gathered data. For example, it may include data normalization and possibly data transformation required for the input data to the AI model.
   Model Training: Model training refers to the actual model training steps as previously outlined.
   Model Evaluation: Model evaluation refers to benchmarking the performance to some model baseline. The iterative steps of model training and model evaluation continue until the acceptable level of performance (as previously exemplified) is achieved.
   Model Registration: Model registration refers to registering the AI model, including any corresponding AI-metadata that provides information on how the AI model was developed, and possibly AI model evaluations performance outcomes.
A deployment stage to make the trained (or re-trained) AI model part of the inference pipeline.
An inference pipeline that may include:
   Data Ingestion: Data ingestion refers to gathering raw (inference) data from a data storage.
   Data Pre-Processing: Data pre-processing stage is typically identical to corresponding processing that occurs in the training pipeline.
   Model Operational: Model operational refers to using the trained and deployed model in an operational mode.
   Data and Model Monitoring: Data & model monitoring refers to validating that the inference data are from a distribution that aligns well with the training data, as well as monitoring model outputs for detecting any performance or operational drifts.
A drift detection stage that informs about any drifts in the model operations.

Depending on where the AI/ML model is located/deployed, use cases of applying AI/ML on air inference over Uu can be divided into two categories:
One-sided AI/ML model at the UE or network node (NW) only: One-sided AI/ML model refers to a UE-sided AI/ML model or a network-sided AI/ML model that can be trained and then used to perform inference without dependency on another AI/ML model at the other end of the communication chain (UE or NW). An example use case of One-sided AI/ML model is UE-sided downlink (DL) spatial beam prediction use case, where an AI/ML model is deployed and operated at a UE. The UE uses the AI/ML model to predict the best DL Transmitter (Tx) beam out of a set A of beams based on the channel measurements of a set B of DL Tx beams, where set B is different from Set A. For example, Set B may be a subset of set A.
Two-sided AI/ML model at both the UE and NW: Two-sided AI/ML model refers to a paired AI/ML model(s), which need to be jointly trained and whose inference is performed jointly across the UE and the NW. In this category, one AI/ML model in the pair cannot be replaced by a legacy non-AI/ML based method. An example use case of Two-sided AI/ML model is a CSI reporting use case where an AI model in the UE compresses DL Channel State Information-Reference Signal (CSI-RS)-based channel estimates, the UE reports the compressed information (represented by a bit bucket) to the network node. Then, another AI model in the network node decompresses those estimates.

### NR Design of Uplink Control Information (UCI) Transmission

A beta factor is used to control the amount of UCI bits that are mapped out. The beta factor is a code rate offset towards the data rate on Physical Uplink Shared Channel (PUSCH). The network can configure different beta offsets for Hybrid Automatic Repeat Request-Acknowledgment (HARQ-ACK) and Channel State Information (CSI). This in order to ensure that the HARQ-ACK and CSI are assigned different code rate depending on the importance of the information. It is further so that the CSI has different beta factors based on if it is CSI part 1 and CSI part 2 due to the similar issue.

In addition, since different coding schemes are applied based on the amount of information bits, there are different beta factors applied, depending on the how many information bits are to be sent by the UE. All of this is configurable by the NW.

Finally, in order to support service with different code rate on PUSCH and potentially Physical Downlink Shared Channel (PDSCH), there may be a need to dynamically adapt the code rate on UCI. Thus, it is possible to assign different beta factors by scheduling a Downlink Control Information (DCI) message.

There currently exist certain challenges, however. For example, in a first scenario, a UCI report from a UE contains some bits whose physical meaning is undefined. In other words, how to interpret the meaning of the bits is not defined in the specification.

For example, for both one-sided and two-sided AI/ML scenarios, a UE may generate a report based on the output(s) of one or more AI/ML models deployed at the UE. This report is transmitted from the UE to a NW in a form of UCI. According to previous techniques handling UCI in NR and LTE, how to interpret the UCI bits carried on PUSCH/PUCCH is explicitly defined. However, for some AI/ML use cases, the UE does not know how to interpretate the meaning of at least part of the UE report that is generated based on the AI/ML model output(s). Take the above-mentioned use case for two-sided AI/ML model for CSI reporting as an example. A report carrying information about compressed CSI is generated from an AI/ML model at a UE, and this report is transmitted from the UE to the NW over Uu. Then, the bits contained in the report is used by the paired AI/ML model at the NW to decompress the CSI. Different from previous techniques for handling CSI reports, there is no explicit definition of the physical meaning of each bit transmitted in the UE report for this AI/ML based CSI reporting use case.

Another type of example use case is for one-sided AI/ML model at a UE when the AI/ML model is firstly trained at the NW side and then transferred from the NW to the UE. In this case, the input and output of the AI/ML model that is deployed at the UE are defined/designed by the NW. Thus, only the model input needs to be specified (i.e., clearly defined) in the standard. However, the model output, which is to be reported from the NE to the NW, does not have to be specified/defined in the standard since the model output can be interpretable by the NW.

When a UE does not know how to interpretate the meaning of at least part of the report that is generated based on its AI/ML model output(s), the UE cannot make proper priority handing for transmitting the bits carried in the report. In general, the current specification lacks mechanisms to support a UE transmitting a report as UCI, when how to interpret at least part of the bits contained in the report is not defined in standard specifications.

As another example, in a second scenario, a UE UCI report contains AI/ML model parameters. For example, a UE may transmit a report to a NW in a form of UCI, where the report contains information about AI/ML model parameters. An example use case is AI/ML model transfer from UE to NW, where an AI/ML model or part of an AI/ML model or multiple AI/ML models is/are trained/retrained at the UE side, then, at least part of the related model parameters is transferred from a UE to the NW as a type of UCI. For instance, consider a two-sided AI/ML model use case, where the model architecture is aligned and fixed at the UE and NW side, and where only the last few layers of the paired models are trained/retrained at the UE side and then transferred from the UE to the NW. Compared to previous UCI types, the bits for model parameters can have different performance requirements in terms of, for example, priority levels, latency, and reliability. In addition, it can be the case that some model parameters are more critical than other model parameters. However, there is no support for differentiated treatment of the bits for AI/ML model parameters when transmitting them as UCI in the uplink.

As still another example, in a third scenario, a UE UCI report contains bits that are generated based on AI/ML model output, and the bits are associated with legacy UCI type(s) (i.e., how to interpret the meaning of the bits is defined in the specification). For example, a UE may transmit a report to a NW in a form of UCI, where the report contains bits generated based on one or more AI/ML model outputs, and the bits are associated with a legacy UCI type(s). An example use case is an AI/ML model at UE for CSI prediction, where the model output includes predicted CSI (e.g., predicted CQI, predicted codebook, predicted L1-RSRP). The UE transmits the predicted CSI as a form of UCI to the NW with/without legacy CSI report. Measured CSI report typically has a better accuracy compared to predicted CSI report. In addition, in case the AI/ML model for CSI prediction does not function properly, the UE may fall back to the legacy CSI report method. However, there is no current support differentiated treatment of the bits that are generated based on an AI/ML model output (e.g., predicted CSI) and the UCI bits for legacy UCI types.

Additionally, for the case of transmitting bit-bucket(s) on PUSCH, the problems of how a UE should perform channel coding for the bit-buckets and how a UE can determine the number of resources used for multiplexing bit-bucket(s) in a PUSCH have not been addressed.

### SUMMARY

Certain aspects of the disclosure and their embodiments may provide solutions to these or other challenges. For example, methods and systems are provided for beta offset configuration for transmitting UCI. Specifically, certain embodiments enable a UE to determine the beta-offset(s) for transmitting bits within one or more bit-buckets to the NW as new type(s) of UCI on PUSCH, where the bit-bucket(s) is/are generated based on one or more AI/ML model(s) deployed at the UE.

According to certain embodiments, a method by a UE for determining beta offset values for transmitting UCI includes receiving, from a network node, at least one beta offset value. The UE transmits the UCI to the network node. The UCI includes one or more bits that are allocated into one or more bit buckets based on the at least one beta offset value. The one or more bit buckets are generated based on an AI model.

According to certain embodiments, a UE for determining beta offset values for transmitting UCI is adapted to receive, from a network node, at least one beta offset value. The UE is adapted to transmit the UCI to the network node. The UCI includes one or more bits that are allocated into one or more bit buckets based on the at least one beta offset value. The one or more bit buckets are generated based on an AI model.

According to certain embodiments, a method by a network node for providing beta offset values for transmission of UCI by a UE includes transmitting, to the UE, at least one beta offset value. The network node receives UCI from the UE. The UCI includes one or more bits that are allocated into one or more bit buckets based on the at least one beta offset, and the one or more bit buckets are generated based on a first AI model.

According to certain embodiments, a network node for providing beta offset values for transmission of UCI by a UE is adapted to transmit, to the UE, at least one beta offset value. The network node is adapted to receive UCI from the UE. The UCI includes one or more bits that are allocated into one or more bit buckets based on the at least one beta offset, and the one or more bit buckets are generated based on a first AI model.

Certain embodiments may provide one or more of the following technical advantage(s). For example, certain embodiments may provide a technical advantage of providing solution(s) for the first scenario described above such that a UE transmits undefined bit-bucket(s) to a NW as UCI on PUSCH where the solution(s) support differentiated handling of bit-bucket transmissions and legacy UCI transmissions. This can result in better support of applying one- and two-sided AI/ML models for the air interface design in 3GPP, especially for the scenarios where the UE and NW nodes are across multiple different vendors. In addition, thanks to the support of separate beta-offset configurations for the undefined bit-bucket transmissions and the legacy UCI type transmissions, certain embodiments may provide a technical advantage for adapting the reliability and priority levels of undefined bit-bucket transmission according to the requirement of the associated AI/ML model, which in turn can result in better radio resource utilization and/or better AI/ML model performance.

As another example, certain embodiments may provide a technical advantage of providing solution(s) for the second scenario described above so as to enable transmission of AI/ML model(s) or part of AI/ML model parameters from a UE to a NW as UCI on PUSCH where differentiated handling of AI/ML model parameter transmissions and legacy UCI transmissions is supported. This can lead to faster and more reliable AI/ML model parameter transfer from UE to NW and better model retaining/update/finetuning at the NW side and/or the UE side.

As still another example, certain embodiments may provide a technical advantage for the third scenario described above so as to enable transmission of AI/ML model output as UCI on PUSCH where differentiated handling of bits generated based on AI/ML model output (e.g., predicted CSI report) and legacy UCI bits (e.g., CSI report based on channel measurements) for a given UCI type (e.g., CSI report) is supported.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates training and inference pipelines and their interactions within a model lifecycle management procedure;

FIG. 2 illustrates an example communication system, according to certain embodiments;

FIG. 3 illustrates an example UE, according to certain embodiments;

FIG. 4 illustrates an example network node, according to certain embodiments;

FIG. 5 illustrates a block diagram of a host, according to certain embodiments;

FIG. 6 illustrates a virtualization environment in which functions implemented by some embodiments may be virtualized, according to certain embodiments;

FIG. 7 illustrates a host communicating via a network node with a UE over a partially wireless connection, according to certain embodiments;

FIG. 8 illustrates a method by a UE for determining beta offset values for transmitting UCI, according to certain embodiments; and

FIG. 9 illustrates a method by a network node for providing beta offset values for transmission of UCI by a UE, according to certain embodiments.

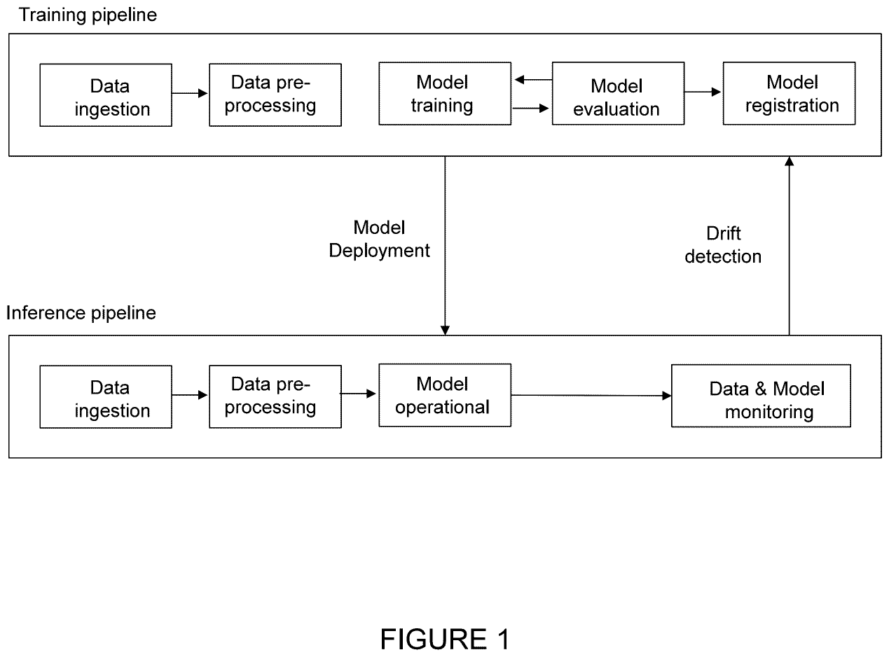

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g., Mobile Switching Center (MSC), Mobility Management Entity (MME), etc.), Operations & Maintenance (O&M), Operations Support System (OSS), Self Organizing Network (SON), positioning node (e.g., E-SMLC), etc.

Another example of a node is user equipment (UE), which is a non-limiting term and refers to any type of wireless device communicating with a network node and/or with another UE in a cellular or mobile communication system. Examples of UE are target device, device-to-device (D2D) UE, vehicular-to-vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node or NW)”, is used. It can be any kind of network node which may comprise base station, radio base station, unit within a base station to handle at least some operations of the functionality, base transceiver station, base station controller, network controller, evolved Node B (eNB), Node B, gNodeB (gNB), relay node, access point, radio access point, Remote Radio Unit (RRU), Remote Radio Head (RRH), Central Unit (e.g., in a gNB), Distributed Unit (e.g., in a gNB), Baseband Unit, Centralized Baseband, C-RAN, access point (AP), device supporting D2D communication, a Location Management Function (LMF), or other type of location server, etc.

The term radio access technology (RAT) may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

Herein, the terms “ML-model” and “AI-model”, “AI-based feature” and “ML-based feature” are used interchangeably. An AI/ML model can be defined as a functionality or be part of a functionality that is deployed/implemented in a first node. This first node can receive a message from a second node indicating that the functionality is not performing correctly such as, for example, when prediction error is higher than a pre-defined value, error interval is not in acceptable levels, or prediction accuracy is lower than a pre-defined value. Further, an AI/ML model can be defined as a feature or part of a feature that is implemented/supported in a first node. This first node can indicate the feature version to a second node. If the ML-model is updated, the feature version maybe changed by the first node.

An ML-model may correspond to a function that receives one or more inputs (e.g., measurements) and provides, as output, one or more prediction(s)/estimates of a certain type. In one example, an ML-model may correspond to a function that receives, as input, the measurement of a reference signal at time instance t0 (e.g., transmitted in beam-X) and provides, as output, the prediction of the reference signal in timer t0+T. In another example, an ML-model may correspond to a function that receives, as input, the measurement of a reference signal X (e.g., transmitted in beam-x), such as an SSB whose index is ‘x’, and provides, as output, the prediction of other reference signals transmitted in different beams such as, for example, reference signal Y (e.g., transmitted in beam-x), such as an SSB whose index is ‘x’.

Another example is a ML model for aid in CSI estimation. In such a setup, the ML-model will be a specific ML-model with a UE side and an ML-model with a NW side. Together, both ML-models provide a joint network. The function of the ML-model at the UE would be to compress a channel input, and the function of the ML-model at the NW side would be to decompress the received output from the UE. It is further possible to apply something similar for positioning, wherein the input may be a channel impulse in some form that is related to a certain reference point (typically a TP (transmit point)) in time. The purpose on the NW side would be to detect different peaks within the impulse response that reflect the multipath experienced by the radio signals arriving at the UE side. For positioning, another way is to input multiple sets of measurements into an ML network and, based on that, derive an estimated position of the UE.

Another ML-model would be an ML-model to be able to aid the UE in channel estimation or interference estimation for channel estimation. The channel estimation could, for example, be for the PDSCH and be associated with a specific set of reference signals patterns that are transmitted from the NW to the UE. The ML-model will then be part of the receiver chain within the UE and may not be directly visible within the reference signal pattern that is configured/scheduled to be used between the NW and UE.

Another example of an ML-model for CSI estimation is to predict a suitable CQI, PMI, RI, CSI-RS resource indicator (CRI) or similar value at a future time, which may be, for example, a certain number of slots after the UE has performed the last measurement. The future time may also target a specific slot in time in the future.

According to certain embodiments, solutions are provided for beta offset configuration for transmitting UCI. Specifically, certain embodiments enable a UE to determine the beta-offset(s) for a UE to transmit bits within one or more bit-buckets to the NW as new type(s) of UCI on PUSCH, where the bit-bucket(s) is/are generated based on one or more AI/ML model(s) at the UE.

According to certain embodiments, a new set of configuration parameters are added into the standard for configuring the beta-offset values for bit-bucket transmission(s) as UCI on PUSCH. The set of configuration parameter(s) includes at least one of the following:
A set of higher-layer parameters in an RRC message for configuring the beta-offset values for the bit-bucket(s) transmission on PUSCH.
New beta-offset mapping tables defined for bit-bucket(s) transmission on PUSCH or reusing a (subset) of beta-offset mapping table of a legacy UCI type for a bit-bucket priority level.
New rules on how to select a beta-offset value for a UCI type based on the size of the bits of a bit-bucket.

In some embodiments, the meaning of at least part of the bits within a bit-bucket is not defined in the standard specification. That is, the standard does not specify how to interpret these bits at the receiver. In other embodiments, the meaning of all the bits contained in the bit-bucket are not defined in the standard. In other words, the data block contents are not previously defined, while the format and transmission parameters of the data block will be defined as disclosed herein.

In some embodiments, a bit-bucket is only decodable by another AI/ML model that is paired with the AI/ML model that encodes the bit-bucket (e.g., the paired AI/ML model at the NW for the two-sided AI/ML model use cases) or by a node in the NW that has trained/designed this AI/ML model (e.g., for the model sharing use cases where the model is trained by the NW and transferred from the NW to the UE).

In some embodiments, a bit-bucket contains information about AI/ML model parameters.

In some embodiments, the bit-bucket is associated with a legacy UCI type but has a different priority comparing to the legacy UCI bits.

### Example Scenarios and Assumptions

According to certain embodiments, a UE maps bits that it should report on the physical layer to one or several bit-buckets. The content of the bit-buckets is transmitted from the UE to NW. One possibility is that the bits within the bit-bucket(s) are generated by the UE based on the output of one or more AI/ML models at the UE; however, this is not a limitation per say. It could be that, in addition, the bits contained in the bit-buckets are generated from an AI/ML model deployed at the UE that is only decodable by another AI/ML model that is paired with the generating AI/ML model (e.g., the paired AI/ML model at the NW side for the two-sided AI/ML model use cases) or by a NW who has trained/design this AI/ML model and transferred this model to the UE (e.g., for the model sharing use cases).

In some scenarios, how to interpretate of the meaning of the bits may not be known by the transmitting unit within the UE. According to certain embodiments described herein, however, the bits are mapped out to the bit-buckets by forming a new type(s) of UCI. The term bit-bucket could also be expressed as logical channel, queue, list or similar naming convention.

Each of the bit buckets may have a maximum number of bits. Alternatively, the bit buckets may not have a maximum number of bits. However, as described when mapping out the bits within the bit-buckets to the channel (e.g., PUCCH or PUSCH), there may be a need to prioritize which bits from which bit-bucket is mapped out. Some of the bits may not be mapped out and transmitted, while some of the bits will be mapped out and transmitted by the UE.

The different bit-buckets may contain bits of higher reliability and/or priority requirements as compared to legacy UCI types. Such a scenario may require separate treatment between the bit-buckets and the legacy UCI. Legacy UCI constitutes, for example, HARQ-ACK, Scheduling Request (SR), and CSI. HARQ-ACK can include HARQ-ACK, HARQ-Non-Acknowledgement (HARQ-NACK), or potentially Discontinuous Transmission (DTX). SR can be positive or negative SR for one combination of logical channels on Medium Access Control (MAC) or single logical channels. CSI can be Rank Indicator (RI), Layer Indicator (LI), Channel quality indicator (CQI), Precoding Matrix Indicator (PMI), CRI, and Layer 1 Reference Signal Received Power (L1-RSRP). For some of the sub-parts of CSI, it is further possible to have sub-band or wideband reports such as, for example, for PMI or CQI.

As an example, to enable the AI/ML model to achieve a target performance, particular embodiments may require a higher reliability of the bits associated with a certain bit-bucket(s) as compared to a bits associated with the legacy CSI report transmission. For example, this may be due to higher entropy of the model-generated data contents and due to more severe consequences of individual bit errors in the received and decoded data. If the bits in the bit-bucket(s) are transmitted as UCI on PUSCH, a lower modulation order and/or coding rate may need to be configured for transmitting the bits in the bit-bucket(s) as compared to transmitting the same size of a legacy CSI report on PUSCH.

As another example, in a particular embodiment, the UCI bits, which consist of bits associated with bit-bucket(s) and legacy UCI types, are configured to be transmitted on a PUCCH, and the number of the UCI bits is larger than the maximum UCI size that can be supported by this PUCCH resource. In this scenario, the bit-bucket(s) should be prioritized compared to some legacy UCI types such as, for example, by discarding part or all the legacy CSI bits from the transmission. If the maximum UCI size is less than maximum number of bits and if the bit-buckets have different priority levels, part or all of the bits associated with bit-buckets with lower priority are also discarded.

As another example, in a particular embodiment, the UE is required to transmit bits associated with bit-bucket(s) together with legacy CSI report as UCI on PUSCH, and the bit-bucket(s) needs to be encoded with a lower coding rate as it is targeting a lower BLER target compared to legacy CSI report. For this case, different beta offsets should be configured for bits associated with bit-bucket(s) and legacy CSI bits, so that the bits associated with the bit-bucket(s) is transmitted with a lower coding rate by the UE to the NW.

According to certain embodiments, a new type of UCI (denoted herein as “bit-bucket”), which is different from legacy UCI types, is introduced to support the transmission of bits associated with one or more bit-bucket(s) from UE to NW. As part of executing an AI/ML model or other functions that generate a report that is to be sent to NW as UCI, the UE may map the bits that are supposed to be reported to one or more bit-buckets. The UE may also map some bits that are to be reported with some of the legacy UCI types. The bits within the bit-buckets are later mapped out to be transmitted together with the legacy UCI types. It should be understood that the mapping to the bit-bucket can be logical mapping purely and bits by themselves do not need to move around in the memory, for example, of the UE to be mapped.

### Beta-Offset Configuration for Transmitting Bits in One or More Bit Bucket(s) in PUSCH

According to certain embodiments, a UE is configured to transmit/report the bits in one or more bit-buckets in PUSCH. The PUSCH transmission can be scheduled by a DCI format or is associated with a configured grant. To support this, a new set of report configuration parameters and network signaling is defined.

Beta offset values are used for a UE to determine a number of resources for multiplexing UCI in a PUSCH. The beta offset value(s) is/are indicated to the UE either by one or more parameter(s) in the DCI format scheduling the PUSCH transmission or by higher layers, together with a set of predefined mapping tables where each mapping table defines a mapping between beta offset values for a certain type(s) of UCI and the indexes signaled by higher layers.

As an example, in a particular embodiment, if a UE is scheduled to transmit the bits within one or more bit-bucket(s) with priority level bit-bucket #0 in a PUSCH, then, Offsets

$${β}_{offset}^{b i t - bucket , 0}$$

are configured for the UE to use depending on the numbers of bits associated with priority level bit-bucket #0. For instance,

$${β}_{offset , 0}^{b i t - bucket , 0} , {β}_{offset , 1}^{b i t - bucket , 0} , or {β}_{offset , 2}^{b i t - bucket , 0}$$

can be configured for the UE to use if the UE multiplexes up to N1 bits, more than N1 and up to N2 bits, and more than N2 bits within one or more bit-bucket(s) with priority bit-bucket #0 in the PUSCH transmission, respectively.

The beta-factor will generally be applied as follows for bit-bucket #x follows:

$${Q}_{bucket - ♯ x}^{′} = min \{ ⌈ \frac{( {O}_{bucket - ♯ 0} + {L}_{bucket - ♯ 0} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{U L - {SCH}^{- 1}}} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{prev}^{′} \}$$

where
O_{bucket-#x} is the number of bits for bit-bucket #x;
if O_{bucket-#x}≥360, L_{bucket-#x}=11; otherwise L_{bucket-#x} is the number of CRC bits for bit-bucket #x;

$${β}_{offset}^{PUSCH} = {β}_{offset , \# y}^{b i t - bucket , ♯ x} ;$$

C_{UL-SCH} is the number of code blocks for UL-SCH of the PUSCH transmission;
if the DCI format scheduling the PUSCH transmission includes a CBGTI field indicating that the UE shall not transmit the r-th code block, Kᵣ=0; otherwise, Kᵣ is the r-th code block size for UL-SCH of the PUSCH transmission;

$${M}_{s c}^{PUSCH}$$

is the schedule bandwidth of the PUSCH transmission, expressed as a number of subcarriers;

$${M}_{s c}^{PT - RS} ( l )$$

is the number of subcarriers in OFDM symbol l that carries PTRS, in the PUSCH transmission;

$${Q}_{prev}^{′}$$

is the UCI bits that has been previously derived to be mapped out on PUSCH

$${M}_{sc}^{UCI} ( l )$$

is the number of resource elements that can be used for transmission of UCI in OFDM symbol l, for

$$l = 0 , 1 , 2 , … , {N}_{symb , all}^{PUSCH} - 1 ,$$

in the PUSCH transmission and

$${N}_{symb , all}^{PUSCH}$$

is the total number of OFDM symbols of the PUSCH, including all OFDM symbols used for DMRS;
for any OFDM symbol that carries DMRS of the PUSCH,

$${M}_{s c}^{UCI} ( l ) = 0 ; \qquad ( 1 )$$

for any OFDM symbol that does not carry DMRS of the PUSCH,

$${M}_{s c}^{UCI} ( l ) = {M}_{s c}^{PUSCH} - {M}_{s c}^{PT - RS} ( l ) ;$$

α is configured by higher layer parameter scaling.

### Semi-Static Configuration of Beta Offset Values

In a particular embodiment, the set of beta offset values

$$( e . g . , {β}_{offset , 0}^{b i t - bucket , 0} , {β}_{offset , 1}^{b i t - bucket , 0} , and {β}_{offset , 2}^{b i t - bucket , 0} )$$

can be signaled to the UE semi-statically using higher layer parameters (e.g., RRC parameters betaOffsetBitBucketPri0-Index1, betaOffsetBitBucketPri0-Index2, and betaOffsetBitBucketPri0-Index3) to provide a set of indexes

$$( e . g . , {I}_{offset , 0}^{b i t - bucket , 0} , {I}_{offset , 1}^{b i t - bucket , 0} , and {I}_{offset , 2}^{b i t - bucket , 0} )$$

to a predefined/specified beta offset value mapping table. An example of the predefined/specified beta offset value mapping table is shown as Table 1 below.

TABLE 1
Mapping of beta_offset values for bits within one or more bit-bucket(s)
associated with priority level bit-bucket #0 and the index signalled
by higher layers

| ${I}_{offset , 0}^{bit - bucket , 0} or {I}_{offset , 1}^{bit - bucket , 0} or {I}_{offset , 2}^{Bit - bucket , 0}$ | ${β}_{offset}^{bit - bucket , 0}$ |
|---|---|
| 0 | 1.000 |
| 1 | 2.000 |
| 2 | 2.500 |
| 3 | 3.125 |
| 4 | 4.000 |
| 5 | 5.000 |
| 6 | 6.250 |
| 7 | 8.000 |
| 8 | 10.000 |
| 9 | 12.625 |
| . . . | . . . |

In a particular embodiment, a set of beta offset values is configured for the UE to transmit/report/multiplex the bits within one or more bit-bucket(s) associated with a certain priority level in a PUSCH, and the UE selects one beta offset value from the configured set of values based on the number of bits contained in the one or more bit-bucket(s).

In a particular embodiment, the beta offset values for transmitting/reporting/multiplexing bits within one or more bit-buckets associated with a certain priority level in a PUSCH are semi-statically configured by higher layer parameter(s) (e.g., a set of RRC parameters used for semi-statical configuration of beta offset values for multiplexing bits in bit-bucket(s) in PUSCH). The higher layer parameter(s) provide a set of indexes to one or more predefined/specified beta offset value mapping table(s).

In a particular embodiment, for each bit-bucket priority level (e.g., bit-bucket #0, bit-bucket #1 or bit-bucket #2), a beta offset table is configured for mapping of beta offset values for this priority level and the indexes signaled by higher layers. The beta offset table can be designed based on a finite set of bit-bucket sizes, or a defined range of bit-bucket sizes, or/and a defined range of BLER targets for a set of configured AI/ML models. In a further particular embodiment, the same beta offset mapping table is shared among different bit-bucket priority levels. In a further particular embodiment, a legacy beta offset mapping table for a legacy UCI type such as, for example, Table 9.3-1 or Table 9.3-2 in 3GPP TS 38.213, is used as the beta offset table for bits within one or more bit-bucket(s) associated with one or more priority levels.

### Dynamic Configuration of Beta Offset Values:

The set of beta offset values

$$( e . g . , {β}_{offset , 0}^{b i t - bucket , 0} , {β}_{offset , 1}^{b i t - bucket , 0} , and {β}_{offset , 2}^{b i t - bucket , 0} )$$

can also be signaled to the UE dynamically.

As an example, a set of beta offset values

$$( e . g . , a set of \{ {β}_{offset , 0}^{b i t - bucket , 0} , {β}_{offset , 1}^{b i t - bucket , 0} , and {β}_{offset , 2}^{b i t - bucket , 0} \} )$$

or indexes (e.g., a set of {betaOffsetBitBucketPri0-Index1, betaOffsetBitBucketPri0-Index2, and betaOffsetBitBucketPri0-Index3}) can be configured by higher layers for dynamic configuration of beta offset values. For example, if the PUSCH transmission is scheduled by a DCI format that does not include a beta_offset indicator field for bits within bit-bucket(s), and if the UE is provided an indication to use dynamic beta offset configuration by higher layer signaling, the UE applies the beta offset values that is determined from the first set of values/indexes that are configured by higher layers for the dynamic beta offset configuration.

In a particular embodiment, the beta offset values for transmitting, reporting, and/or multiplexing bits within one or more bit-buckets associated with a certain priority level in a PUSCH are configured by higher layer signaling that indicates using dynamic beta offset configuration together with a DCI format scheduling the PUSCH transmission. The DCI format does not include a beta_offset indicator filed for bits within bit-bucket(s).

As another example, in a particular embodiment, a beta_offset indicator field with one or a few bits can be included in the DCI format that schedules the PUSCH transmission from the UE. In addition, the UE is provided, by each of {betaOffsetBitBucketPri0-Index1, betaOffsetBitBucketPri0-Index2, and betaOffsetBitBucketPri0-Index3}, a set of two or more

$${I}_{offset}^{b i t - bucket , 0}$$

indexes from the mapping table (e.g., Table 1) for multiplexing the bits associated with priority level bit-bucket #0 in the PUSCH transmission. The beta offset indicator field indicates a

$${I}_{offset}^{b i t - bucket , 0}$$

value from the respective sets of values based on another table (e.g., Table 2), which maps the beta_offset indicator values to offset indexes.

TABLE 2
Mapping of four beta_offset indicator values to offset indexes

| beta_offset indicator | $( {I}_{offset , 0}^{bit - bucket , 0} , {I}_{offset , 1}^{bit - bucket , 0} , and {I}_{offset , 2}^{bit - bucket , 0} ) ,$ |
|---|---|
| ‘00’ | 1^{st} offset index provided by higher layers |
| ‘01’ | 2^{nd} offset index provided by higher layers |
| ‘10’ | 3^{rd} offset index provided by higher layers |
| ‘11’ | 4^{th} offset index provided by higher layers |

In a particular embodiment, the beta offset values for transmitting, reporting, and/or multiplexing bits within one or more bit-buckets associated with a certain priority level in a PUSCH are dynamically configured by a beta_offset field in the DCI format scheduling the PUSCH transmission. The beta_offset field can be the same field as used for legacy UCI types, or it can be a separate field for bits within one or more bit-bucket(s) only.

In a particular embodiment, the table(s) used for mapping beta_offset indicator for bits within one or more bit-bucket(s) is/are the same as for legacy UCI types (i.e., Table 9.3-3 or/and Table 9.3-3A of 3GPP TS 38.213).

Configuration of Beta Offset Values for Bits in Bit-Bucket(s) with the Same Priority Level of a Legacy UCI Type

In the cases where the bits within one or more bit-buckets have the same priority level as for a legacy UCI type (e.g., bit-bucket #1 has the same priority level of Part 1 CSI report), then, two options may be considered for signaling the beta offset values for the bits within one or more bit-buckets:
Option 1: In a particular embodiment, different sets of beta offset parameters are configured for bits within one or more bit-buckets (e.g., bits associated with the priority level bit-bucket #1) and legacy UCI type (e.g., Part 1 CSI report), respectively. Both the semi-static and dynamic signaling methods described above can be used for this option.
Option 2: In a particular embodiment, a single set of beta offset values can be configured for both the legacy UCI type (e.g., Part 1 CSI report) and for the bits within the one or more bit-buckets (e.g., bits associated with the priority level bit-bucket #1). The legacy parameters for configuring beta offset values for the legacy UCI type can be reused for configuring the single set of beta offset values. The UE selects one beta offset value from the configured set of values based on the total number of bits contained in the one or more bit-bucket(s) and bits for the legacy UCI type.

In a particular embodiment, different sets of beta offset parameters (e.g., offset indexes) are configured for a UE to transmit, report, and/or multiplex a legacy UCI type (e.g., HARQ-ACK, SR, part 1 CSI reports, or part 2 CSI reports) and/or bits in one or more bit-buckets in a PUSCH, where the bits in one or more bit-buckets have the same priority level as the legacy UCI type. That is, a new set of beta offset configuration parameters are introduced in the specification(s) for configuring a UE to transmit, report, and/or multiplex bits within one or more bit-buckets in a PUSCH. In this case, the beta offset mapping table can be the same or different for the bits within one or more bit-buckets as compared to the one for the legacy UCI type.

In a particular embodiment, a single set of beta offset values is configured for a UE to transmit, report, and/or multiplex a legacy UCI type (e.g., HARQ-ACK, SR, part 1 CSI reports, or part 2 CSI reports) and/or bits in one or more bit-buckets in a PUSCH, where the bits in one or more bit-buckets have the same priority level as the legacy UCI type. In this case, the beta offset value mapping table for the legacy UCI type is reused for bits within one or more bit-buckets that are associated with the same priority level. In a further particular embodiment, the UE selects one beta offset value from the configured set of values based on the total number of bits contained in the one or more bit-bucket(s) and bits for the legacy UCI type.

As an example, assume that bit-bucket #1 has the same priority level of Part 1 CSI report, and bit-bucket #2 has the same priority level of Part 2 CSI report. In addition, the beta offset table defined for Part 1 CSI report is reused for bits associated with priority level bit-bucket #1, and the beta offset table defined for Part 2 CSI report is reused for bits associated with priority level bit-bucket #2. A separate set of beta offset configuration parameters, i.e.,

$${β}_{offset}^{b i t - bucket , 1} , {I}_{offset , 0}^{b i t - bucket , 0} and {I}_{offset , 1}^{b i t - bucket , 0} ,$$

is configured for bits associated with bit-bucket #1, and a separate set of beta offset configuration parameters, i.e.,

$${β}_{offset}^{b i t - bucket , 2} , {I}_{offset , 0}^{b i t - bucket , 2} and {I}_{offset , 1}^{b i t - bucket , 2} ,$$

is configured for bits associated with bit-bucket #2. As Part 1 CSI and Part 2 CSI share the same beta offset mapping table, this mapping table is also used for bits associated with priority levels bit-bucket #1 and bit-bucket #2. Table 3 shows an example of a predefined/specified beta offset value mapping table for CSI and/or bits associated with bit-bucket #1 and/or bits associated with bit-bucket #2.

TABLE 3
Mapping of beta_offset values for CSI and/or bits associated with
bit-bucket #1 and/or bits associated with bit-bucket #2 and the index
signalled by higher layers

| ${I}_{offset , 0}^{CSI - 1} or {I}_{offset , 1}^{CSI - 1}$ | ${β}_{offset}^{CSI - 1}$ |
|---|---|
| ${I}_{offset , 0}^{CSI - 2} or {I}_{offset , 1}^{CSI - 2}$ | ${β}_{offset}^{CSI - 2}$ |
| ${I}_{offset , 1}^{bit - bucket , 1} or {I}_{offset , 1}^{bit - bucket , 1}$ | ${β}_{offset}^{bit - bucket , 1}$ |
| ${I}_{offset , 1}^{bit - bucket , 2} or {I}_{offset , 1}^{bit - bucket , 2}$ | ${β}_{offset}^{bit - bucket , 2}$ |
| 0 | 1.125 |
| 1 | 1.250 |
| 2 | 1.375 |
| . . . | . . . |
| 13 | 6.250 |
| 14 | 8.000 |
| 15 | 10.000 |
| 16 | 12.625 |
| 17 | 15.875 |
| 18 | 20.000 |
| 19 | Reserved |

In a particular embodiment, at least a separate scaling factor is configured for limiting the number of resource elements allocated for multiplexing bits within one or more bit-bucket(s) on PUSCH. The scaling factor is a parameter configured in the IE PUSCH-Config.

Examples of Implementation of Proposed Beta-Offset Configuration Solutions into the Standard Specifications

Some examples on how to implement the proposed solution in the standard specifications are provided below. The examples below assume that:
There are three priority levels (bit-bucket #0, bit-bucket #1, bit-bucket #2) defined for transmitting bits within bit-bucket(s) in a PUSCH.
Three indexes are configured for bit-bucket #0, two indexes for bit-bucket #1, and two indexes for bit-bucket #2.
A priority rule is defined such that the UCI should be handled in descending priority level as HARQ-ACK/NACK, followed by SR and bit-bucket #0 on the same priority, followed by CSI part 1 and bit-bucket #1 on the same priority and followed by CSI part 2 and bit-bucket #2 on the same priority.
Legacy beta offset tables are reused for bits within bit-bucket(s)

It may be noted that the implementations/updates to specifications are not limited to this example case.

### 3GPP TS 38.213 Section 9.3:

If a DCI format that does not include a beta_offset indicator field schedules the PUSCH transmission from the UE and the UE is provided betaOffsetsBitBucket-r18=‘semiStatic’, the UE applies the

$${β}_{offset}^{b i t - bucket , 0} , {β}_{offset}^{b i t - bucket , 1} , and {β}_{offset}^{b i t - bucket , 2}$$

values that are provided by betaOffsetsBitBucket-r18=‘semiStatic’ for the corresponding bits of priority bit-bucket #0, bits of priority bit-bucket #1 and bits of priority bit-bucket #2.
If the PUSCH transmission is with a configured grant and the UE is provided CG-BitBucket-OnPUSCH=‘semiStatic’, the UE applies the

$${β}_{offset}^{b i t - bucket , 0} , {β}_{offset}^{b i t - bucket , 1} , and {β}_{offset}^{b i t - bucket , 2}$$

values that are provided by CG-BitBucket-OnPUSCH=‘semiStatic’ for the corresponding bits of priority bit-bucket #0, bits of priority bit-bucket #1 and bits of priority bit-bucket #2.
If the PUSCH transmission is scheduled by DCI format 0_0 and the UE is provided betaOffsetsBitBucket-r18=‘dynamic’, the UE applies the

$${β}_{offset}^{b i t - bucket , 0} , {β}_{offset}^{b i t - bucket , 1} , and {β}_{offset}^{b i t - bucket , 2}$$

values that are determined from the first value of betaOffsetsBitBucket-r18=‘dynamic’.
Offsets

$${β}_{offset}^{b i t - bucket , 0}$$

are configured to values according to Table 9.3-x. The betaOffsetBitBucketPri0-Index1, betaOffsetBitBucketPri0-Index2, and betaOffsetBitBucketPri0-Index3 respectively provide indexes

$${I}_{offset , 0}^{bit - bucket , 0} , {I}_{offset , 1}^{bit - bucket , 0} , and {I}_{offset , 2}^{bit - bucket , 0}$$

for the UE to use if the UE multiplexes up to N1 bits, more than N1 and up to N2 bits, and more than N2 bits within one or more bit-bucket(s) with priority bit-bucket #0 in the PUSCH transmission, respectively.

TABLE 9.3-x
Mapping of beta_offset values for HARQ-ACK information and/or for CG-UCI, and/or
bits with priority level bit-bucket #0 and the index signalled by higher layers

| ${I}_{offset , 0}^{HARQ - ACK} or {I}_{offset , 1}^{HARQ - ACK} or {I}_{offset , 2}^{HARQ - ACK} or {I}_{offset}^{CG - UCI}$ | |
|---|---|
| ${I}_{offset , 0}^{HARQ - ACK , 0} or {I}_{offset , 1}^{HARQ - ACK , 0} or {I}_{offset , 2}^{HARQ - ACK , 0}$ | ${β}_{offset}^{HARQ - ACK} or {β}_{offset}^{CG - UCI} or$ |
| ${I}_{offset , 0}^{HARQ - ACK , 1} or {I}_{offset , 1}^{HARQ - ACK , 1} or {I}_{offset , 2}^{HARQ - ACK , 1}$ | ${β}_{offset}^{HARQ - ACK , 0} or {β}_{offset}^{HARQ - ACK , 1} or$ |
| ${I}_{offset , 0}^{bit - bucket , 0} or {I}_{offset , 1}^{bit - bucket , 0} or {I}_{offset , 2}^{Bit - bucket , 0}$ | ${β}_{offset}^{bit - bucket , 0}$ |
| 0 | 1.000 |
| 1 | 2.000 |
| 2 | 2.500 |
| 3 | 3.125 |
| 4 | 4.000 |
| 5 | 5.000 |
| 6 | 6.250 |
| 7 | 8.000 |
| 8 | 10.000 |
| 9 | 12.625 |
| 10 | 15.875 |
| 11 | 20.000 |
| 12 | 31.000 |
| 13 | 50.000 |
| 14 | 80.000 |
| 15 | 126.000 |
| 16 | 0.6 |
| 17 | 0.4 |
| 18 | 0.2 |
| 19 | 0.1 |
| 20 | 0.05 |
| 21 | Reserved |
| 22 | Reserved |
| 23 | Reserved |
| 24 | Reserved |
| 25 | Reserved |
| 26 | Reserved |
| 27 | Reserved |
| 28 | Reserved |
| 29 | Reserved |
| 30 | Reserved |
| 31 | Reserved |

For the case of using different sets of beta offset parameters for bits within bit-bucket(s) and CSI reports:
Offset

$${β}_{offset}^{bit - bucket , 1} and {β}_{offset}^{bit - bucket , 2} ,$$

respectively, are configured to values according to Table 9.3-y. The betaOffsetBitBucketPri1-Index1 and betaOffsetBitBucketPri2-Index1 respectively provide indexes

$${I}_{offset , 0}^{bit - bucket , 1} and {I}_{offset , 0}^{bit - bucket , 2}$$

for the UE to use if the UE multiplexes up to M1 bits within one or more bit-bucket(s) with priority bit-bucket #1 or with priority bit-bucket #2 in the PUSCH. The betaOffsetBitBucketPri1-Index2 and betaOffsetBitBucketPri2-Index2 respectively provide indexes

$${I}_{offset , 1}^{bit - bucket , 1} and {I}_{offset , 1}^{bit - bucket , 2}$$

for the UE to use if the UE multiplexes more than M1 bits within one or more bit-bucket(s) with priority bit-bucket #1 or with priority bit-bucket #2 in the PUSCH.
If a DCI format that includes a beta offset indicator field with one bit or two bits, as configured by UCI-OnPUSCH-BitBucket-r18, schedules the PUSCH transmission from the UE, the UE is provided by each of {betaOffsetBitBucketPri0-Index1, betaOffsetBitBucketPri0-Index2, betaOffsetBitBucketPri0-Index3} a set of two or four

$${I}_{offset}^{bit - bucket , 0}$$

indexes from Table 9.3-x for multiplexing within one or more bit-bucket(s) with priority bit-bucket #0 in the PUSCH transmission and by each of {betaOffsetBitBucketPri1-Index1, betaOffsetBitBucketPri1-Index2} a set of two or four

$${I}_{offset}^{bit - bucket , 1}$$

indexes, and by each of {beatOffsetBitBucketPri2-Index1, betaOffsetBitBucketPri2-Index2} a set of two or four

$${I}_{offset}^{bit - bucket , 2}$$

indexes from Table 9.3-y, respectively, for multiplexing bits within one or more bit-bucket(s) with priority bit-bucket #1 and bits within one or more bit-bucket(s) with priority bit-bucket #2, respectively, in the PUSCH transmission. The beta_offset indicator field indicates a

$${I}_{offset}^{bit - bucket , 0}$$

value a

$${I}_{offset}^{bit - bucket , 1}$$

value, and a

$${I}_{offset}^{bit - bucket , 2}$$

value from the respective sets of values, with the mapping defined in Table 9.3-z and in Table 9.3-k.

TABLE 9.3-y
Mapping of beta_offset values for CSI and/or bits with priority level
bit-bucket #1 and/or bits with priority level bit-bucket #2 and the index
signalled by higher layers

| ${I}_{offset , 0}^{CSI - 1} or {I}_{offset , 1}^{CSI - 1}$ | ${β}_{offset}^{CSI - 1}$ |
|---|---|
| ${I}_{offset , 0}^{CSI - 2} or {I}_{offset , 1}^{CSI - 2}$ | ${β}_{offset}^{CSI - 2}$ |
| ${I}_{offset , 1}^{bit - bucket , 1} or {I}_{offset , 1}^{bit - bucket , 2}$ | ${β}_{offset}^{bit - bucket , 1}$ |
| ${I}_{offset , 1}^{bit - bucket , 2} or {I}_{offset , 1}^{bit - bucket , 2}$ | ${β}_{offset}^{bit - bucket , 2}$ |
| 0 | 1.125 |
| 1 | 1.250 |
| 2 | 1.375 |
| 3 | 1.625 |
| 4 | 1.750 |
| 5 | 2.000 |
| 6 | 2.250 |
| 7 | 2.500 |
| 8 | 2.875 |
| 9 | 3.125 |
| 10 | 3.500 |
| 11 | 4.000 |
| 12 | 5.000 |
| 13 | 6.250 |
| 14 | 8.000 |
| 15 | 10.000 |
| 16 | 12.625 |
| 17 | 15.875 |
| 18 | 20.000 |
| 19 | Reserved |
| 20 | Reserved |
| 21 | Reserved |
| 22 | Reserved |
| 23 | Reserved |
| 24 | Reserved |
| 25 | Reserved |
| 26 | Reserved |
| 27 | Reserved |
| 28 | Reserved |
| 29 | Reserved |
| 30 | Reserved |
| 31 | Reserved |

TABLE 9.3-z
Mapping of four beta_offset indicator values to offset indexes

| | $( {I}_{offset , 0}^{HARQ - ACK} or {I}_{offset , 1}^{HARQ - ACK} or {I}_{offset , 2}^{HARQ - ACK} ) ,$ |
|---|---|
| | $( {I}_{offset , 0}^{HARQ - ACK , 0} or {I}_{offset , 1}^{HARQ - ACK , 0} or {I}_{offset , 2}^{HARQ - ACK , 0} ) ,$ |
| | $( {I}_{offset , 0}^{HARQ - ACK , 1} or {I}_{offset , 1}^{HARQ - ACK , 1} or {I}_{offset , 2}^{HARQ - ACK , 1} ) ,$ |
| | $( {I}_{offset , 0}^{CSI - 1} or {I}_{offset , 0}^{CSI - 2} ) , ( {I}_{offset , 1}^{CSI - 1} or {I}_{offset , 1}^{CSI - 2} ) ,$ |
| | $( {I}_{offset , 0}^{bit - bucket , 0} or {I}_{offset , 1}^{bit - bucket , 0} or {I}_{offset , 2}^{bit - bucket , 0} ) ,$ |
| | $( {I}_{offset , 0}^{bit - bucket , 1} or {I}_{offset , 1}^{bit - bucket , 1} ) ,$ |
| beta_offset indicator | $( {I}_{offset , 0}^{bit - bucket , 2} or {I}_{offset , 1}^{bit - bucket , 2} ) ,$ |
| ‘00’ | 1^{st} offset index provided by higher layers |
| ‘01’ | 2^{nd} offset index provided by higher layers |
| ‘10’ | 3^{rd} offset index provided by higher layers |
| ‘11’ | 4^{th} offset index provided by higher layers |

TABLE 9.3-k
Mapping of two beta_offset indicator values to offset indexes

| | $( {I}_{offset , 0}^{HARQ - ACK} or {I}_{offset , 1}^{HARQ - ACK} or {I}_{offset , 2}^{HARQ - ACK} ) ,$ |
|---|---|
| | $( {I}_{offset , 0}^{HARQ - ACK , 0} or {I}_{offset , 1}^{HARQ - ACK , 0} or {I}_{offset , 2}^{HARQ - ACK , 0} ) ,$ |
| | $( {I}_{offset , 0}^{HARQ - ACK , 1} or {I}_{offset , 1}^{HARQ - ACK , 1} or {I}_{offset , 2}^{HARQ - ACK , 1} ) ,$ |
| | $( {I}_{offset , 0}^{CSI - 1} or {I}_{offset , 0}^{CSI - 2} ) , ( {I}_{offset , 1}^{CSI - 1} or {I}_{offset , 1}^{CSI - 2} ) ,$ |
| | $( {I}_{offset , 0}^{bit - bucket , 0} or {I}_{offset , 1}^{bit - bucket , 0} or {I}_{offset , 2}^{bit - bucket , 0} ) ,$ |
| | $( {I}_{offset , 0}^{bit - bucket , 1} or {I}_{offset , 1}^{bit - bucket , 1} ) ,$ |
| beta_offset indicator | $( {I}_{offset , 0}^{bit - bucket , 2} or {I}_{offset , 1}^{bit - bucket , 2} ) ,$ |
| ‘0’ | 1^{st} offset index provided by higher layers |
| ‘1’ | 2^{nd} offset index provided by higher layers |

For the case of using the same set of beta offset parameters for Part 1 CSI reports also for bits associated with priority level bit-bucket #1, and using the same set of beta offset parameters for Part 2 CSI reports also for bits associated with priority level bit-bucket #2, and sharing the same beta offset mapping table, i.e. Table 9.3-2 of 3GPP TS 38.213:
Offset

$${β}_{offset}^{CSI - 1}$$

for multiplexing Part 1 CSI report and/or bit-bucket #1 are configured to values according to Table 9.3-2. The betaOffsetCSI-Part1-Index1 respectively provide indexes

$${I}_{offset , 0}^{CSI - 1}$$

for the UE to use if the UE multiplexes up to in total of M2 bits for Part 1 CSI reports and/or bits associated with bit-bucket #1 in the PUSCH. The betaOffsetCSI-Part1-Index2 respectively provide indexes

$${I}_{offset , 1}^{CSI - 1}$$

for the UE to use if the UE multiplexes more than M2 bits for Part 1 CSI reports and/or bits associated with bit-bucket #1 in the PUSCH.
Offsets

$${β}_{offset}^{CSI - 2}$$

for multiplexing Part 2 CSI report and/or bit bucket #2 are configured to values according to Table 9.3-2. The betaOffsetCSI-Part2-Index1 respectively provide indexes

$${I}_{offset , 0}^{CSI - 2}$$

and or the UE to use it the UE multiplexes up to in total of M3 bits for Part 2 CSI reports and/or bits associated with bit-bucket #2 in the PUSCH. The betaOffsetCSI-Part2-Index2 respectively provide indexes

$${I}_{offset , 1}^{CSI - 2}$$

for the UE to use it the UE multiplexes more than M3 bits for Part 2 CSI reports and/or bits associated with bit-bucket #2 in the PUSCH.

### 3GPP TS 38.331 Section 6.3.2

As an example of specification updates, at least some of the following parameters are added:

In IE PUSCH-Config:

BetaOffsetsBitBucket-r18 ::= CHOICE {

| | |
|---|---|
| Dynamic | SEQUENCE (SIZE (1..4)) OF BetaOffsetsBitBucket-18, |
| semiStatic | BetaOffsetsBitBucket-18 |

}

A new IE BetaOffsetsBitBucket-18, which is used to configure beta-offset values for multiplexing bits in bit-bucket(s) on PUSCH:

| BetaOffsetsBitBucket-18 ::= | SEQUENCE { |
|---|---|
| betaOffsetBitBucketPri0-Index1 | INTEGER(0..31) |
| OPTIONAL, -- Need S | |
| betaOffsetBitBucketPri0-Index2 | INTEGER(0..31) |
| OPTIONAL, -- Need S | |
| betaOffsetBitBucketPri0-Index3 | INTEGER(0..31) |
| OPTIONAL, -- Need S | |
| betaOffsetBitBucketPri1-Index1 | INTEGER(0..31) |
| OPTIONAL, -- Need S | |
| betaOffsetBitBucketPri1-Index2 | INTEGER(0..31) |
| OPTIONAL, -- Need S | |
| betaOffsetBitBucketPri2-Index1 | INTEGER(0..31) |
| OPTIONAL, -- Need S | |
| betaOffsetBitBucketPri2-Index2 | INTEGER(0..31) |

OPTIONAL -- Need S
}

As another example of specification update, in IE PUSCH-Config, at least some of the following parameters are added:

### In IE PUSCH-Config:

| UCI-OnPUSCH-BitBucket-r18 ::= | | SEQUENCE { |
|---|---|---|
| | betaOffsetsBitBucket-r18 | CHOICE { |
| | dynamic | CHOICE { |
| | oneBit | SEQUENCE (SIZE (2)) OF |

BetaOffsetsBitBucket-18,

| | |
|---|---|
| twoBits | SEQUENCE (SIZE (4)) OF |

BetaOffsetsBitBucket-18

| }, | |
|---|---|
| semiStatic | BetaOffsetsBitBucket-18 |
| } | OPTIONAL, - |

| | |
|---|---|
| - | Need M |
| | scaling |

ENUMERATED { f0p5, f0p65, f0p8, f1 }

}

### In IE ConfiguredGrantConfig:

| betaOffsetCG-BitBucket-r18 | INTEGER (0..31) |
|---|---|
| OPTIONAL, -- Need R | |
| CG-BitBucket-On PUSCH ::= CHOICE { | |
| dynamic | SEQUENCE (SIZE (1..4)) OF |
| BetaOffsetsBitBucket-18, | |
| semiStatic | BetaOffsetsBitBucket-18 |

}

### 3GPP TS 38.212 Section 7.3

The following information may be added in DCI format 0_1
Bit-bucket indicator/request field, which consists of 0, 1, or a few bits determined by the number of bit-bucket(s) or number of bit-bucket priority levels or number of AI/ML models that a UE is configured with by higher layer parameters. It is used to indicate the UE which bit-bucket(s) should be reported/transmitted on the PUSCH. It can be a single bit-bucket indicator field for all the priority levels defined for bits within bit-bucket(s), or one bit-bucket indicator per bit-bucket priority levels.

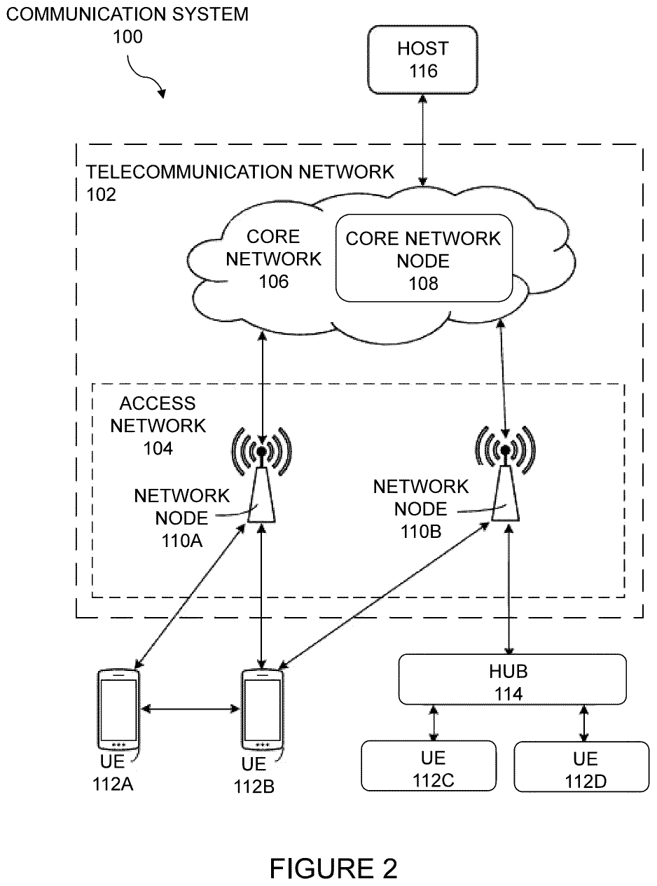

FIG. 2 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 2 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

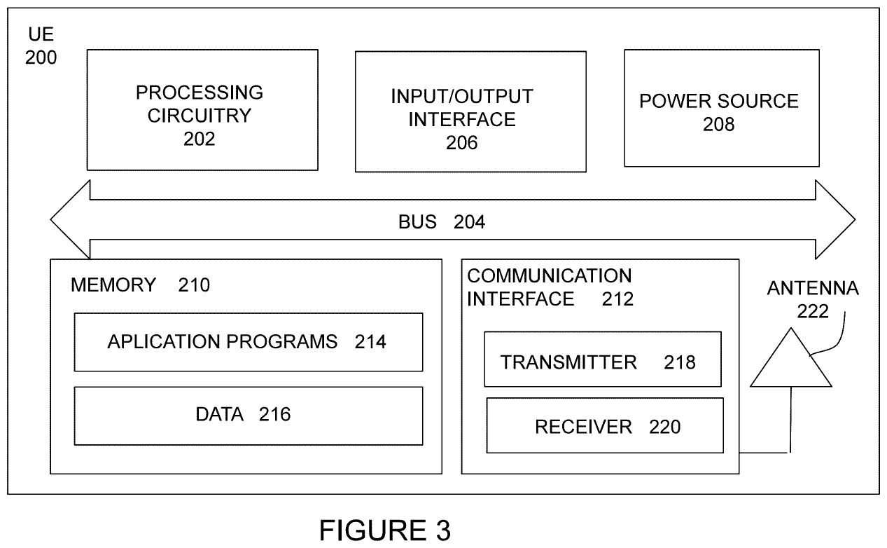

FIG. 3 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 3. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 3.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

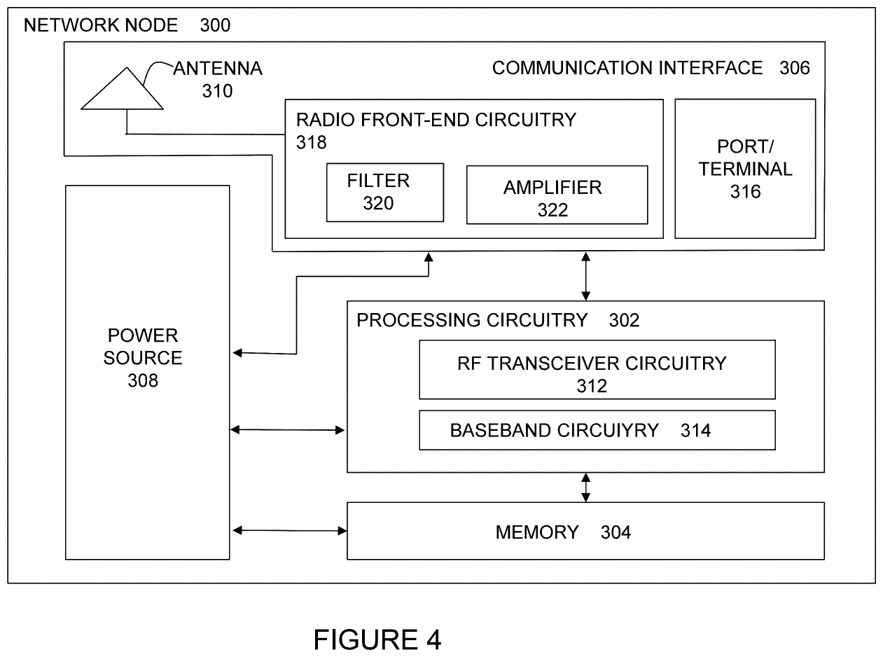

FIG. 4 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 4 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

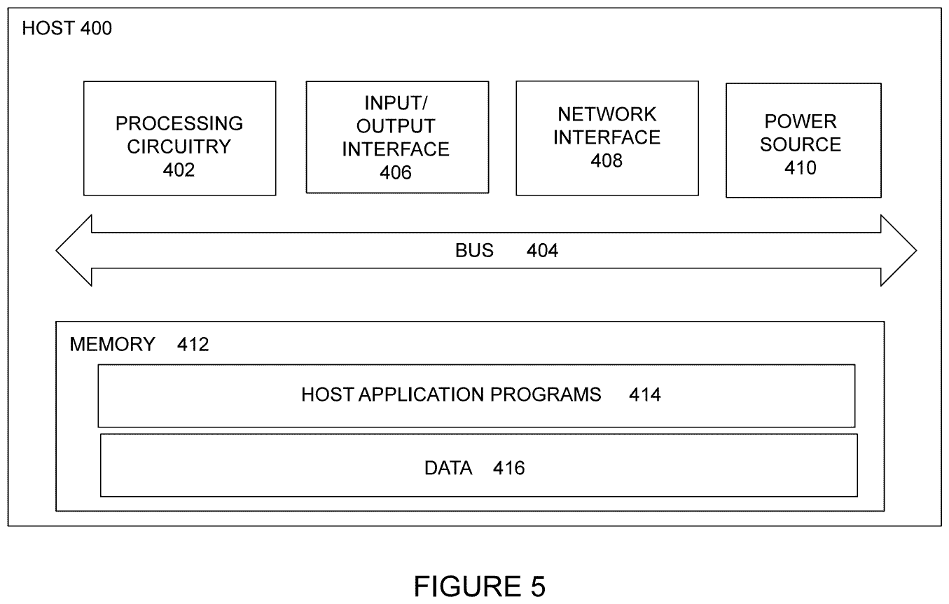

FIG. 5 is a block diagram of a host 400, which may be an embodiment of the host 116 of FIG. 2, in accordance with various aspects described herein.

As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

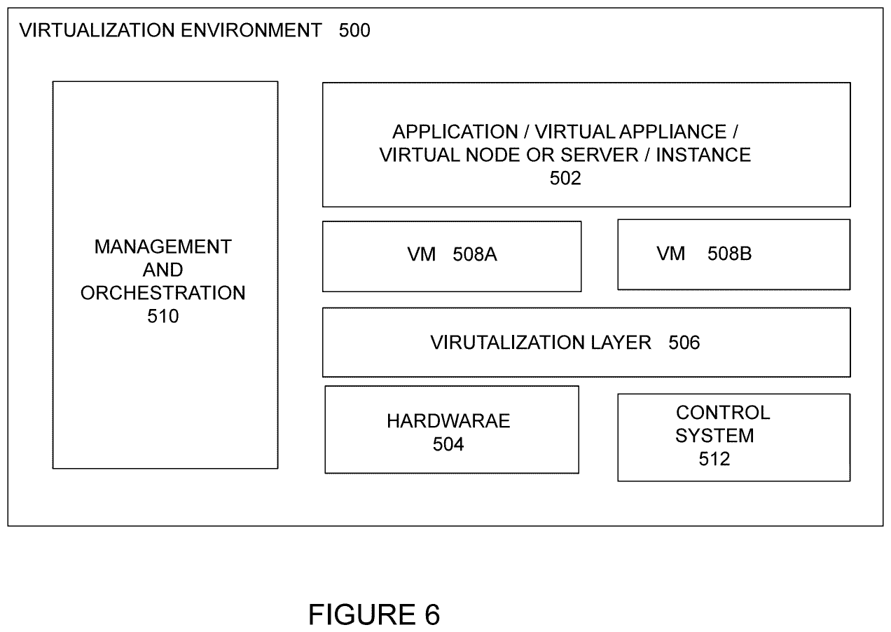

FIG. 6 is a block diagram illustrating a virtualization environment 500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

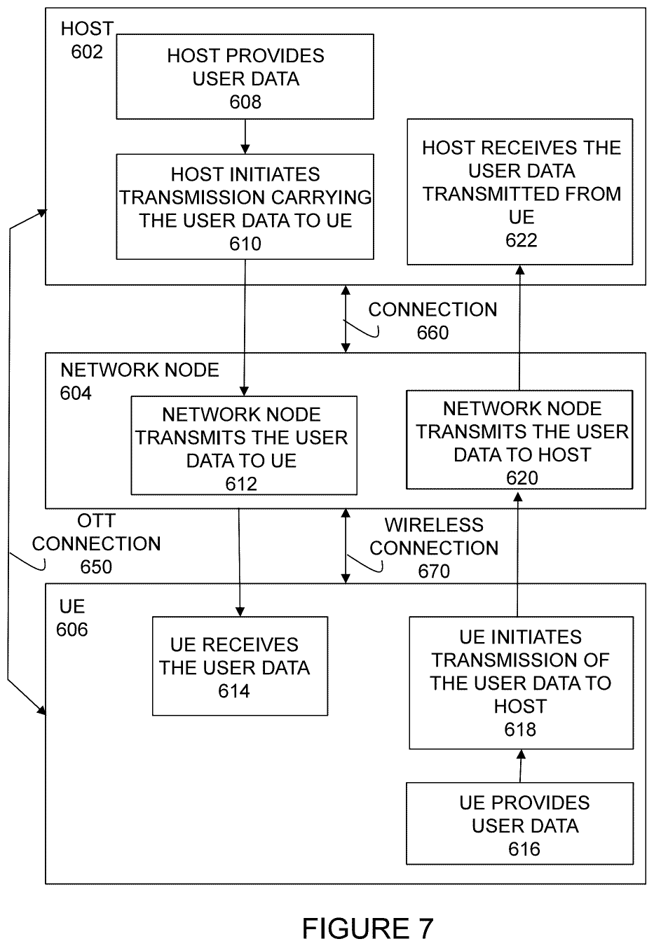

FIG. 7 shows a communication diagram of a host 602 communicating via a network node 604 with a UE 606 over a partially wireless connection in accordance with some embodiments.

Example implementations, in accordance with various embodiments, of the UE (such as a UE 112a of FIG. 2 and/or UE 200 of FIG. 3), network node (such as network node 110a of FIG. 2 and/or network node 300 of FIG. 4), and host (such as host 116 of FIG. 2 and/or host 400 of FIG. 5) discussed in the preceding paragraphs will now be described with reference to FIG. 7.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 2) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

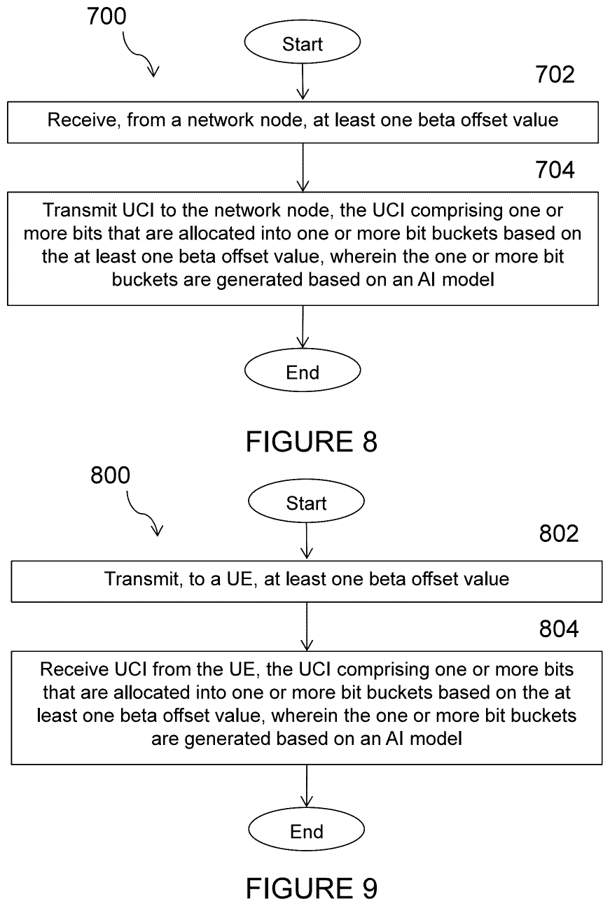

FIG. 8 illustrates a method 700 by a UE 112 for determining beta offset values for transmitting UCI, according to certain embodiments. The method includes receiving, from a network node 110, at least one beta offset value, at step 702. At step 704, the UE 112 transmits the UCI to the network node 110. The UCI includes one or more bits that are allocated into one or more bit buckets based on the at least one beta offset value. The one or more bit buckets are generated based on an AI model.

In a particular embodiment, the UE 112 generates the one or more bit buckets based on an AI parameter associated with the AI model.

In a further particular embodiment, the one or more bit buckets include the AI parameter used to generate the one or more bit buckets.

In a particular embodiment, the UE 112 generates the one or more bit buckets based on an output of the AI model.

In a particular embodiment, at least one bit in at least one bit bucket has a meaning that is undefined in a specification.

In a particular embodiment, the at least one beta offset value is received in DCI that is used to schedule the transmission of the UCI.

In a particular embodiment, the at least one beta offset value is received via a higher layer.

In a particular embodiment, the UE 112 stores a set of mapping tables, and each mapping table defines a mapping between one or more beta offset values for a type of UCI and an index.

In a further particular embodiment, the UE 112 checks at least one mapping table in the set of mapping tables for the one or more bit buckets associated with the type of UCI and a priority level.

In a further particular embodiment, the UE 112 receives the index via a higher layer.

In a particular embodiment, the one or more bit buckets are associated with one or more priority levels.

In a further particular embodiment, each bit bucket is associated with a respective one of a plurality of priority levels.

In a further particular embodiment, all of the one or more bit buckets are associated with a priority level.

In a further particular embodiment, the at least one beta offset value comprises a set of beta offset values, and the UE 112 selects a beta offset value from the set of beta offset values based on a number of bits in the one or more bit buckets.

FIG. 9 illustrates a method 800 by a network node 110 for providing beta offset values for transmission of UCI by a UE 112, according to certain embodiments. The method includes transmitting, to the UE 112, at least one beta offset value. The network node 110 receives UCI from the UE 112. The UCI includes one or more bits that are allocated into one or more bit buckets based on the at least one beta offset, and the one or more bit buckets are generated based on a first AI model.

In a particular embodiment, the network node 110 uses a second AI model to decode the UCI, and the second AI model is paired with the first AI model.

In a particular embodiment, the one or more bit buckets include an AI parameter used by the UE to generate the one or more bit buckets.

In a particular embodiment, at least one bit in at least one bit bucket has a meaning that is undefined in a specification.

In a particular embodiment, the at least one beta offset value is transmitted in DCI that is used to schedule the transmission of the UCI.

In a particular embodiment, the at least one beta offset value is transmitted via a higher layer.

In a particular embodiment, the network node 110 transmits, to the UE 112, a set of mapping tables, and each mapping table defines a mapping between one or more beta offset values for a type of UCI and an index.

In a further particular embodiment, the network node 110 transmits, via a higher layer, the index to the UE.

In a particular embodiment, the one or more bit buckets are associated with one or more priority levels.

In a further particular embodiment, each bit bucket is associated with a respective one of a plurality of priority levels.

In a further particular embodiment, all of the one or more bit buckets are associated with a priority level.

In a particular embodiment, the at least one beta offset value includes a set of beta offset values, and the bits are multiplexed into the bit buckets based on a beta offset value that is selected from the set of beta offset values based on a number of bits in the one or more bit buckets. In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for determining beta offset values for transmitting bits within bit-buckets, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for indicating beta offset values for transmission of bits within bit-buckets by a user equipment (UE), the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for determining beta offset values for transmitting bits within bit-buckets, the method comprising: receiving, from a network node, at least one beta offset value; transmitting uplink control information (UCI) to the network node, the UCI comprising bits that are allocated into one or more bit buckets based on the at least one beta offset.

Example Embodiment C2. The method of Example Embodiment C1, comprising generating the bit buckets based on a AI/ML parameter associated with an AI/ML model.

Example Embodiment C3. The method of Example Embodiment C2, wherein at least one bit bucket includes the AI/ML parameter used to generate the bit buckets.

Example Embodiment C4. The method of any one of Example Embodiments C1 to C3, wherein at least one bit in at least one bit bucket is undefined.

Example Embodiment C5. The method of any one of Example Embodiments C1 to C4, wherein all of the bits in at least one bit bucket are undefined.

Example Embodiment C6. The method of any one of Example Embodiments C1 to C5, wherein the at least one beta offset value is received in DCI that is used to schedule the transmission of the UCI.

Example Embodiment C7. The method of any one of Example Embodiments C1 to C5, wherein the at least one beta offset value is received via a higher layer.

Example Embodiment C8. The method of Example Embodiment C7, further comprising receiving a set of mapping tables, wherein each mapping table defines a mapping between beta offset values for a type of UCI and an index.

Example Embodiment C9. The method of any one of Example Embodiments C7 to C8, comprising receiving the index via a higher layer.

Example Embodiment C10. The method of any one of Example Embodiments C1 to C9, wherein the at least one beta offset value is associated with a priority level.

Example Embodiment C11. The method of any one of Example Embodiments C1 to C10, wherein the at least one beta offset value comprises a set of beta offset values, and the method comprises selecting a beta offset value from the set of beta offset values based on a number of bits in the one or more bit buckets.

Example Embodiment C12. The method of Example Embodiments C1 to C11, further comprising: providing user data; and forwarding the user data to a host via the transmission to the network node.

Example Embodiment C13. A user equipment comprising processing circuitry configured to perform any of the methods of Example Embodiments C1 to C11.

Example Embodiment C14. A wireless device comprising processing circuitry configured to perform any of the methods of Example Embodiments C1 to C11.

Example Embodiment C15. A computer program comprising instructions which when executed on a computer perform any of the methods of Example Embodiments C1 to C11.

Example Embodiment C16. A computer program product comprising computer program, the computer program comprising instructions which when executed on a computer perform any of the methods of Example Embodiments C1 to C11.

Example Embodiment C17. A non-transitory computer readable medium storing instructions which when executed by a computer perform any of the methods of Example Embodiments C1 to C11.

### Group D Example Embodiments

Example Embodiment D1. A method by a network node for providing beta offset values for transmitting bits within bit-buckets, the method comprising: transmitting, to a user equipment (UE), at least one beta offset value; and receiving, from the UE, uplink control information (UCI) comprising bits that are allocated into one or more bit buckets based on the at least one beta offset.

Example Embodiment D2. The method of Example Embodiment D1, comprising at least one of: generating the bit buckets based on a AI/ML parameter associated with an AI/ML model, and using the AI/ML parameter and the AI/ML model to decode the UCI.

Example Embodiment D3. The method of Example Embodiment D2, wherein at least one bit bucket includes the AI/ML parameter used to generate the bit buckets.

Example Embodiment D4. The method of any one of Example Embodiments D1 to D3, wherein at least one bit in at least one bit bucket is undefined.

Example Embodiment D5. The method of any one of Example Embodiments D1 to D4, wherein all of the bits in at least one bit bucket are undefined.

Example Embodiment D6. The method of any one of Example Embodiments D1 to D5, wherein the at least one beta offset value is transmitted in DCI that is used to schedule the transmission of the UCI.

Example Embodiment D7. The method of any one of Example Embodiments D1 to D5, wherein the at least one beta offset value is transmitted via a higher layer.

Example Embodiment D8. The method of Example Embodiment D7, further comprising transmitting, to the UE, a set of mapping tables, wherein each mapping table defines a mapping between beta offset values for a type of UCI and an index.

Example Embodiment D9. The method of any one of Example Embodiments D7 to D8, comprising transmitting, to the UE, the index via a higher layer.

Example Embodiment D10. The method of any one of Example Embodiments D1 to D9, wherein the at least one beta offset value is associated with a priority level.

Example Embodiment D11. The method of any one of Example Embodiments D1 to D10, wherein the at least one beta offset value comprises a set of beta offset values, and wherein the bits are multiplexed into the bit buckets based on a beta offset value that is selected from the set of beta offset values based on a number of bits in the one or more bit buckets.

Example Embodiment D12. The method of any of the previous Example Embodiments, further comprising: obtaining user data; and forwarding the user data to a host or a user equipment.

Example Embodiment D13. A network node comprising processing circuitry configured to perform any of the methods of Example Embodiments D1 to D12.

Example Embodiment D14. A computer program comprising instructions which when executed on a computer perform any of the methods of Example Embodiments D1 to D12.

Example Embodiment D15. A computer program product comprising computer program, the computer program comprising instructions which when executed on a computer perform any of the methods of Example Embodiments D1 to D12.

Example Embodiment D16. A non-transitory computer readable medium storing instructions which when executed by a computer perform any of the methods of Example Embodiments D1 to D12.

### Group E Example Embodiments

Example Embodiment E1. A user equipment comprising: processing circuitry configured to perform any of the steps of any of the Group A and C Example Embodiments; and power supply circuitry configured to supply power to the processing circuitry.

Example Embodiment E2. A network node comprising: processing circuitry configured to perform any of the steps of any of the Group B and D Example Embodiments; power supply circuitry configured to supply power to the processing circuitry.

Example Embodiment E3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method by a user equipment, UE, for determining beta offset values for transmitting uplink control information, UCI, the method comprising:
receiving, from a network node, at least one beta offset value; and
transmitting the UCI to the network node, the UCI comprising one or more bits that are allocated into one or more bit buckets based on the at least one beta offset value, wherein the one or more bit buckets are generated based on an Artificial Intelligence, AI, model.

2. The method of claim 1, comprising generating the one or more bit buckets based on an AI parameter associated with the AI model.

3. The method of claim 2, wherein the one or more bit buckets include the AI parameter used to generate the one or more bit buckets.

4. The method of claim 1, comprising generating the one or more bit buckets based on an output of the AI model.

5. The method of claim 1, wherein at least one bit in at least one bit bucket has a meaning that is undefined in a specification.

6. The method of claim 1, wherein the at least one beta offset value is received in Downlink Control Information, DCI, that is used to schedule the transmission of the UCI.

7. The method of claim 1, wherein the at least one beta offset value is received via a higher layer.

8. The method of claim 1, further comprising storing a set of mapping tables, wherein each mapping table defines a mapping between one or more beta offset values for a type of UCI and an index.

9. The method of claim 8, comprising checking at least one mapping table in the set of mapping tables for the one or more bit buckets associated with the type of UCI and a priority level.

10. The method of claim 8, comprising receiving the index via a higher layer.

11. The method of claim 1, wherein the one or more bit buckets are associated with one or more priority levels.

12. The method of claim 11, wherein each bit bucket is associated with a respective one of a plurality of priority levels.

13. The method of claim 11, wherein all of the one or more bit buckets are associated with a priority level.

14. The method of claim 1, wherein the at least one beta offset value comprises a set of beta offset values, and the method comprises selecting a beta offset value from the set of beta offset values based on a number of bits in the one or more bit buckets.

15. A method by a network node for providing beta offset values for transmission of uplink control information, UCI, by a User Equipment, UE, the method comprising:
transmitting, to the UE, at least one beta offset value; and
receiving UCI from the UE, the UCI comprising one or more bits that are allocated into one or more bit buckets based on the at least one beta offset, wherein the one or more bit buckets are generated based on a first Artificial Intelligence, AI, model.

16. The method of claim 15, comprising:
using a second AI model to decode the UCI, wherein the second AI model is paired with the first AI model.

17. The method of claim 16, wherein the one or more bit buckets include an AI parameter used by the UE to generate the one or more bit buckets.

18. The method of claim 15, wherein at least one bit in at least one bit bucket has a meaning that is undefined in a specification.

19.-26. (canceled)

27. A user equipment, UE, for determining beta offset values for transmitting uplink control information, UCI, the UE adapted to:
receive, from a network node, at least one beta offset value; and
transmit the UCI to the network node, the UCI comprising one or more bits that are allocated into one or more bit buckets based on the at least one beta offset value, wherein the one or more bit buckets are generated based on an Artificial Intelligence, AI, model.

28. (canceled)

29. A network node for providing beta offset values for transmission of uplink control information, UCI, by a User Equipment, UE, the network node adapted to:
transmit, to the UE, at least one beta offset value; and
receive, from the UE, UCI comprising one or more bits that are allocated into one or more bit buckets based on the at least one beta offset, wherein the one or more bit buckets are generated based on a first AI model.

30. (canceled)
